(19) United States
(12) Patent Application Publication
(10) Pub. No.: US 2012/0235651 A1
(43) Pub. Date: Sep. 20, 2012

(54) POWER SUPPLIES AND RELATED METHODS CAPABLE OF REDUCING OUTPUT VOLTAGE RIPPLE

(76) Inventor: Yu-Bin Wang, Hsin-Chu (TW)

(21) Appl. No.: 13/421,876

(22) Filed: Mar. 16, 2012

(30) Foreign Application Priority Data
Mar. 16, 2011 (TW) 100108879

(51) Int. Cl. H02M 1/14

(52) U.S. Cl. 323/234

(57) ABSTRACT

Power supplies and related methods capable of reducing output voltage ripple. A power supply provides an output voltage to a load and controls the output voltage to approach a target voltage. The output voltage is compared with the target voltage to generate a control signal, which controls an output current of the power supply. When the control signal causes an increase in the output current, the target voltage is reduced.

### BACKGROUND OF THE INVENTION

1. Field of the Invention

The present invention relates to power supplies and related methods of reducing output voltage ripple.

2. Description of the Prior Art

For some electronic devices that are very sensitive to supply voltage, e.g. central processing units (CPUs) or optical sensors of digital cameras, variations in voltage provided by a power supply must always be kept within very tight tolerances, or the electronic device may be damaged or have errors in operation.

FIG. 1 shows a power supply 10 and a load 12. Load 12 is shown as a current source 14 which draws a load current I_{LOAD} representing how light or heavy load 12 is, as well as output current I_{OUT} of power supply 10 under stable conditions.

Power supply 10 typically is designed so that its output voltage V_{OUT} can be rapidly stabilized to a fixed voltage regardless of changes in size of load 12. As shown in FIG. 2, when load current I_{LOAD} goes from low to high, because output current I_{OUT} cannot immediately increase with load current I_{LOAD}, output voltage V_{OUT} temporarily drops . However, as power supply 10 increases output current I_{OUT}, output voltage V_{OUT} quickly rises to return to voltage V_{TAR0}. Similarly, when load current I_{LOAD} drops from high to low, output voltage V_{OUT} temporarily exceeds voltage V_{TAR0}, but rapidly drops back to the same voltage V_{TAR0}.

However, some electronic devices have stringent requirements for peak-to-peak output voltage variation of power supply 10, which is shown in FIG. 2 as peak-to-peak variation ΔV_{OUT1}. As shown in FIG. 2, peak-to-peak variation ΔV_{OUT1} comprises overshoot and undershoot of output voltage V_{OUT}.

Peak-to-peak variation of output voltage is known as output voltage ripple, which circuit designers have always had difficulty reducing.

### SUMMARY OF THE INVENTION

According to an embodiment, a method of reducing ripple is for use in a power supply. The power supply provides an output voltage to a load, and causes the output voltage to approach a target voltage. The method comprises comparing the output voltage and the target voltage to generate a control signal, and changing the target voltage according to the control signal. The target voltage is lowered when the control signal indicates that output current increases.

According to an embodiment, a power supply provides an output voltage to a load, and causes the output voltage to approach a target voltage. The power supply comprises a compensation circuit for comparing the output voltage and the target voltage to generate a control signal, and a bias circuit for changing the target voltage according to the control signal. The target voltage is lowered when the control signal indicates that the output current increases.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 illustrates a power supply and a load.

FIG. 2 illustrates peak-to-peak output voltage variation of power supply.

FIG. 3 shows two relationships between output current and target voltage.

FIG. 4 shows a possible waveform of output voltage generated by variation of load current as generated by a power supply corresponding to line 18 of FIG. 3.

FIG. 5A shows a current mode booster according to an embodiment .

FIG. 5B shows a current mode booster according to another embodiment.

FIG. 6A shows an LDO according to an embodiment.

FIG. 6B shows an LDO according to an embodiment.

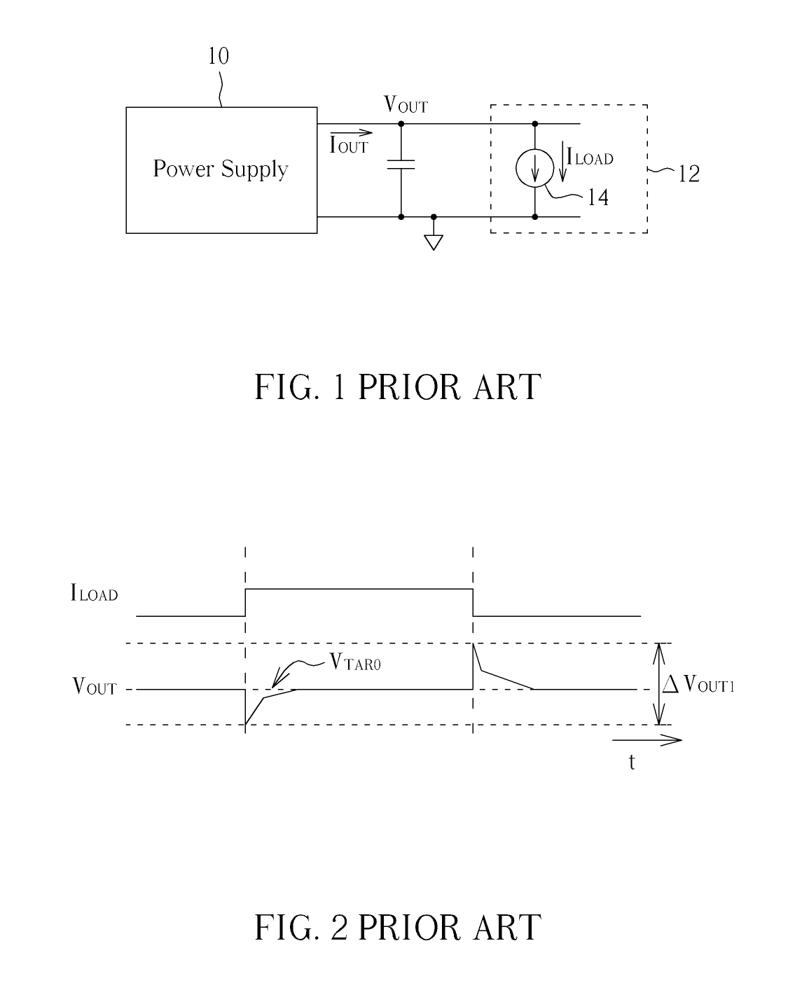

### DETAILED DESCRIPTION

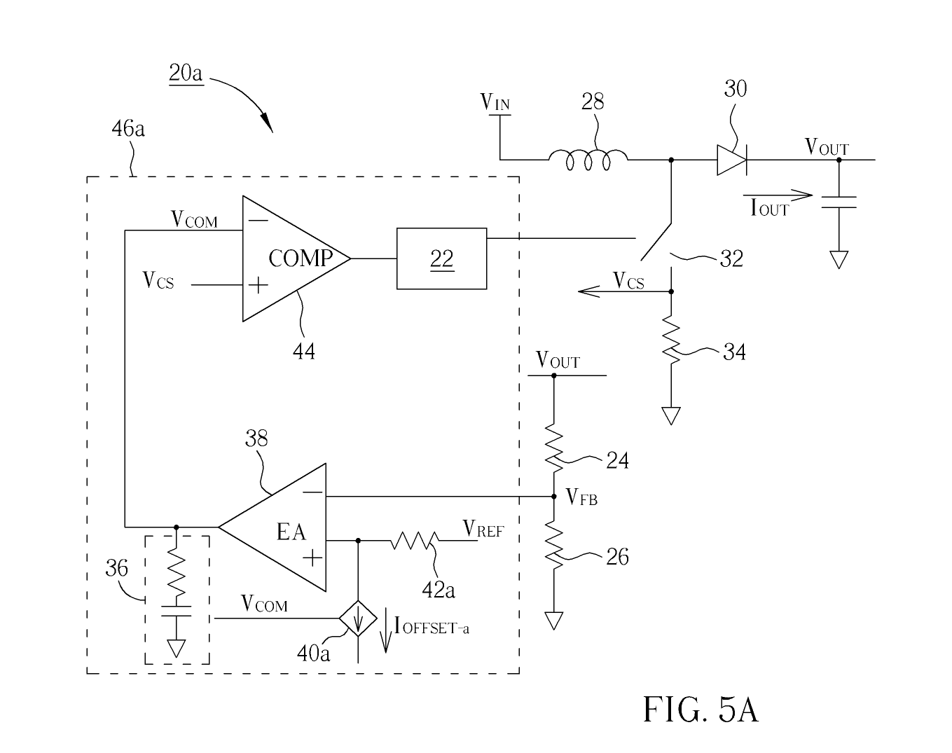

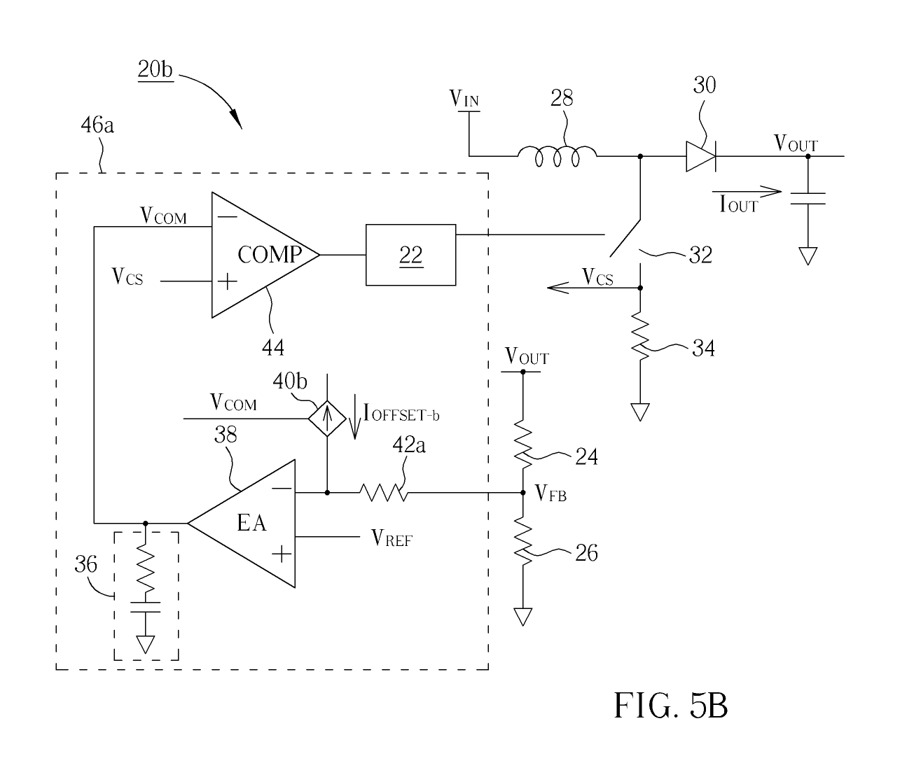

Two lines in FIG. 3 show two relationships between output current I_{OUT} and target voltage V_{TARGET}. Target voltage V_{TARGET} is a desired target for output voltage V_{OUT} of power supply. Line 16 corresponds to a traditional power supply having target voltage V_{TARGET} that is unrelated to variations in output current I_{OUT}, approximately staying at fixed voltage V_{TAR0}. Line 18 corresponds to a power supply according to an embodiment, which has target voltage V_{TARGET} that drops with increased output current I_{OUT}. FIG. 4 shows a possible waveform of output voltage V_{OUT} generated by variation of load current I_{LOAD} as generated by a power supply corresponding to line 18 of FIG. 3. It can be seen from FIG. 4 and FIG. 3 that when load current I_{LOAD} instantaneously increases from I_{OUT1} ^{to I}_{OUT2}, target voltage V_{TARGET} drops from V_{OUT1} to V_{OUT2} as output current I_{OUT} increases from I_{OUT1} to I_{OUT2}. Thus, when load current I_{LOAD} is I_{OUT2}, output voltage V_{OUT} settles to V_{OUT2}. Conversely, when load current I_{LOAD} drops sharply from I_{OUT2} to I_{OUT1}, output voltage V_{OUT} starts changing from V_{OUT2}, and ultimately settles at V_{OUT1}.

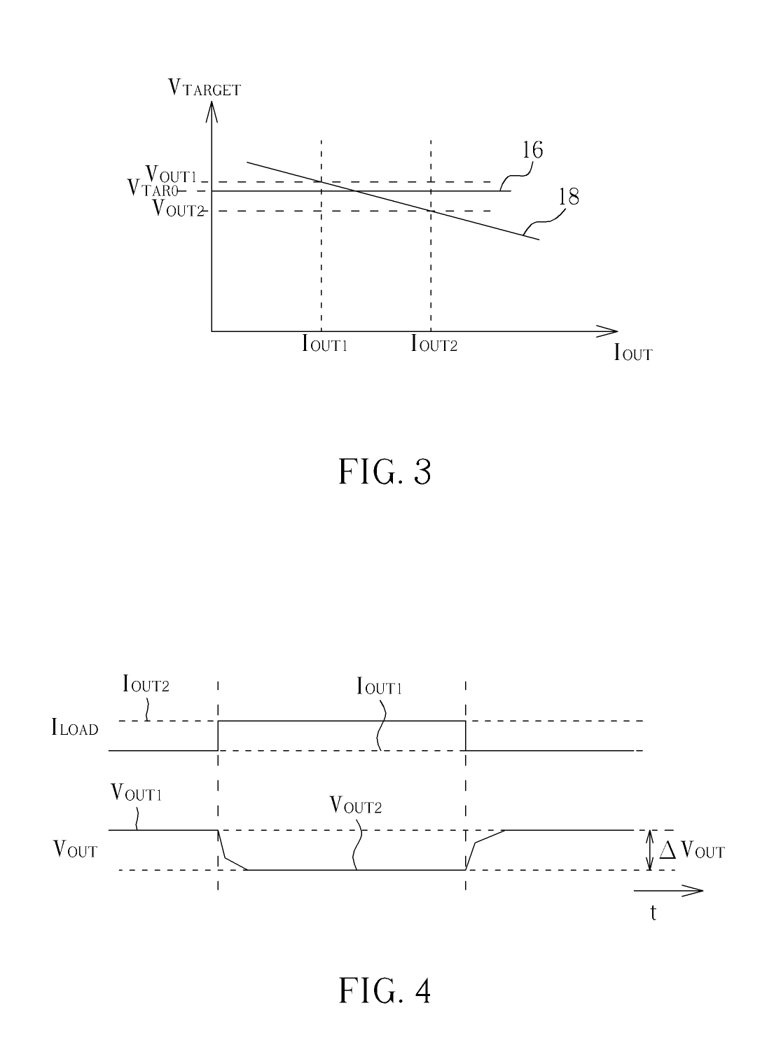

Comparing FIG. 4 with FIG. 2, it can be seen that, through appropriate design, because only one of overshoot and undershoot need be considered, peak-to-peak variation ΔV_{OUT2} in FIG. 4 may be reduced to half of peak-to-peak variation ΔV_{OUT1} of FIG. 2, making it easier to meet requirements of some electronic devices that are sensitive to peak-to-peak output voltage variation.

Line 18 of FIG. 3 represents target voltage V_{TARGET} dropping with increasing output current I_{OUT}. This concept may be used in all kinds of power supplies, e.g. switching mode power supplies (SMPS) or low dropout (LDO) regulators. In the following, two boosters (a type of SMPS) and two LDOs act as embodiments. However, the present invention is not limited to SMPS and LDO architectures, and could be realized in other power supply types not described herein.

### <Booster 1>

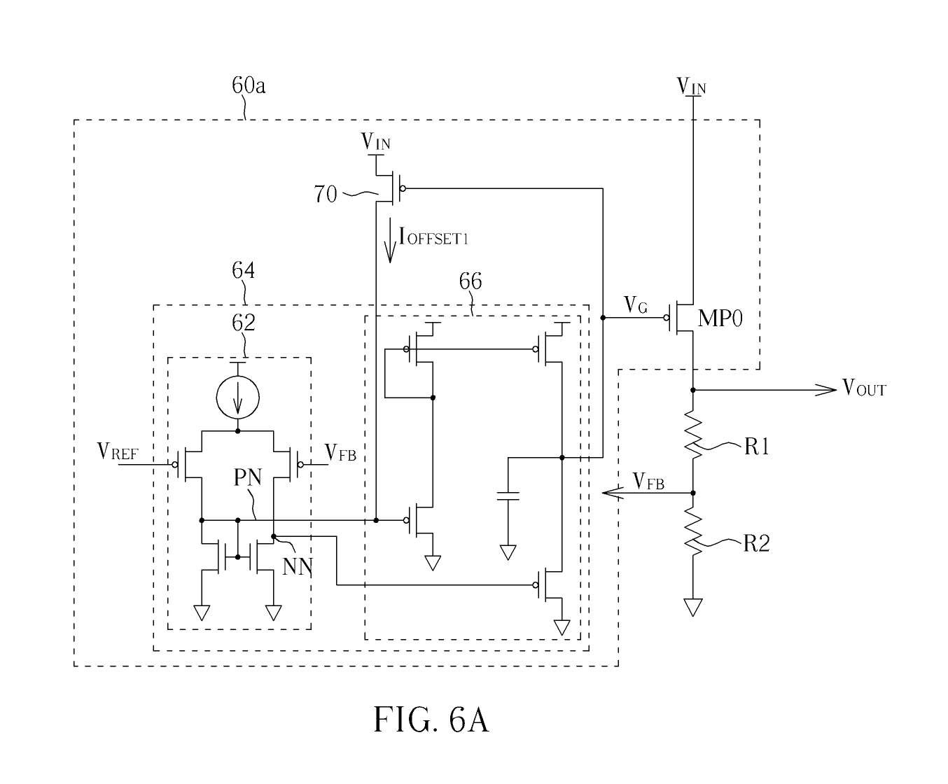

FIG. 5A shows a current mode booster 20a according to an embodiment. Inductor 28, diode 30, power switch 32, current sense resistor 34, voltage divider 24, 26, and power supply controller 46a are interconnected in a typical booster architecture. This power supply architecture is well known in the art, and not described again herein.

Power supply controller 46a periodically switches power switch 32 to make output voltage V_{OUT} approach a target voltage V_{TARGET,} and this target voltage V_{TARGET} is determined by power supply controller 46a. In the embodiment shown in FIG. 5A, error amplifier 38 compares voltages at a positive input node and negative input node thereof. Equivalently, error amplifier 38 compares target voltage V_{TARGET} and output voltage V_{OUT} to generate compensation voltage V_{COM} at output node, which is one node of compensation circuit 36. Compensation voltage V_{COM} can be seen as a control signal for controlling peak value of current sense voltage V_{CS}, and correspondingly controlling output current I_{OUT} flowing through diode 30. High compensation voltage V-_{COM} simultaneously implies peak current sense voltage V_{CS} and high output current I_{OUT}. In an embodiment, the higher the compensation voltage V_{COM}, the higher the peak of current sense voltage V_{CS}, and the higher the duty cycle of power switch 32. Duty cycle is percentage of one switching cycle for which power switch 32 is closed.

Power supply controller 46 has a voltage-controlled current source 40a, which generates offset current I_{OFFSET-a} according to compensation voltage V_{COM}, which is extracted from positive input node of error amplifier 38. The higher compensation voltage V_{COM} is, the larger the offset current I_{OFFSET-a}. Power supply controller 46a has a feedback mechanism that adjusts output voltage V_{OUT} to approach target voltage V_{TARGET,} causing positive input node and negative input node of error amplifier 38 to be a virtual short-circuit (have the same voltage). Thus, target voltage V_{TARGET} and fixed reference voltage V_{REF} have a relationship described by equation (1):

V_{TARGET}*R₂₆/(R₂₄+R₂₆)=V_{REF}−I_{OFFSET-a}*R₄₂ₐ (1)

where R_{X} represents resistance of resistor X. It can be seen from equation (1) that as compensation voltage V_{COM} increases, output current I_{OUT} increases, offset current I_{OFFSET-a} increases, and target voltage V_{TARGET} decreases. In this way, a relationship between target voltage V_{TARGET} and output current I_{OUT} similar to that shown by line 18 of FIG. 3 can be generated, which may reduce output voltage ripple.

### <Booster II>

FIG. 5B shows a current mode booster 20b according to another embodiment. Similarities between the architectures shown in FIG. 5B and FIG. 5A are familiar to those skilled in the art, and are not repeated here. FIG. 5B differs from FIG. 5A in interconnections related to positive and negative input nodes of error amplifier 38. Similarly, based on the concept of virtual short-circuits, relationship between target voltage V_{TARGET} of output voltage V_{OUT} and reference voltage V_{REF} can be derived as equation (2):

V_{TARGET}*R₂₆/(R₂₄+R₂₆)+I_{OFFSET-b}*(R_{42b}+R₂₄*R₂₆/(R₂₄+R₂₆))=V_{REF} (2)

From equation (2), it can be seen that when output current I_{OUT} increases, it implies that compensation voltage V_{COM} increases, offset current I_{OFFSET-b} increases, and target voltage V_{TARGET} decreases.

Similar to booster 20a of FIG. 5A, booster 20b of FIG. 5B can generate a similar relationship between target voltage V_{TARGET} and output current I_{OUT} to that shown by line 18 of FIG. 3.

In FIG. 5A, offset current I_{OFFSET-a} generated by voltage-controlled current source 40a is extracted from positive input node of error amplifier 38. In FIG. 5B, offset current I_{OFFSET-b} generated by voltage-controlled current source 40b is injected into negative input node of error amplifier 38. In other embodiments, an offset current may be extracted from positive input node of error amplifier 38, and another offset current may simultaneously be injected into negative input node.

### <LDO I>

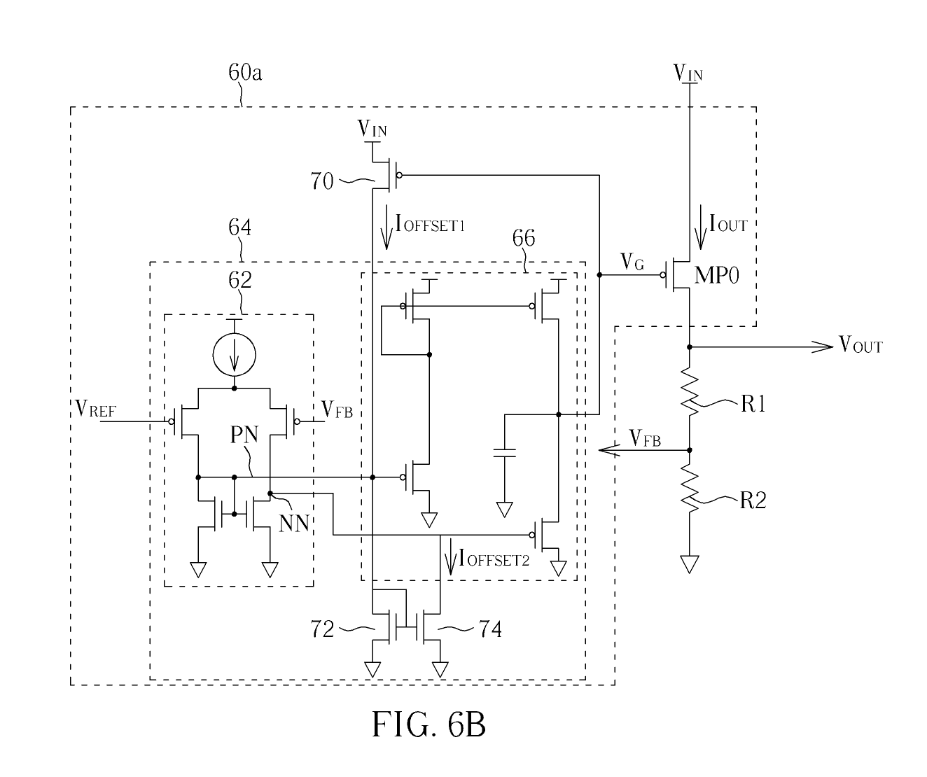

FIG. 6A shows an LDO 60a according to an embodiment. An input power supply node of power component P-type Metal-Oxide-Semiconductor (PMOS) MPO receives input voltage V_{IN}, and an output power supply node provides output voltage V_{OUT}. Central node of voltage divider resistors R1, R2 generates feedback voltage V_{FB}, which equivalently represents output voltage V_{OUT} . Error amplifier 64 can be seen as a compensation circuit, and has comparator 62 and buffer stage 66. Comparator 62 compares reference voltage V_{REF} and feedback voltage V_{FB}, and generates a differential signal from two differential output nodes (PN and NN). Buffer stage 66 generates control signal V_{G} at power component PMOS MPO according to differential signal. Control signal V_{G} approximately determines output current I_{OUT}. Circuit operation of error amplifier 64 is known to those skilled in the art, and not repeated here.

PMOS 70 can be seen as a shifter circuit, and generates offset current I_{OFFSET1} according to control signal V_{G}. PMOS 70 and PMOS MPO can approximately be seen as a current mirror, so that offset current I_{OFFSET1} roughly reflects output current I_{OUT}. Offset current I_{OFFSET1} is injected into differential output node PN. When offset current I_{OFFSET1} is 0, LDO 60a causes output voltage V_{OUT} to approach a target voltage V_{TARGET}, and this target voltage V_{TARGET} causes feedback voltage V_{FB} to equal reference voltage V_{REF}. However, when offset current I_{OFFSET1} increases, feedback voltage V_{FB} needs to drop to keep the same differential signal that existed prior to offset current I_{OFFSET1} increasing. Thus, it can be seen that when offset current I_{OFFSET1} increases, output current I_{OUT} increases, and target voltage V_{TARGET} decreases. In this way, a relationship between target voltage V_{TARGET} and output current I_{OUT} similar to that shown by line 18 of FIG. 3 can be generated, which may reduce output voltage ripple.

### <LDO II>

FIG. 6B shows an LDO 60b according to an embodiment. Similarities and differences between FIG. 6B and FIG. 6A are apparent to those skilled in the art, and not repeated here. Different from FIG. 6A, shifter circuit of FIG. 6B comprises PMOS 70, N-type Metal-Oxide-Semiconductor (NMOS) 72 and NMOS 74. Offset current I_{OFFSET1} of FIG. 6B is not injected into differential output node PN, but flows through current mirror formed by NMOS 72 and NMOS 74 to generate offset current I_{OFFSET2} extracted through differential output node NN.

According to circuit description of FIG. 6A, those with basic circuit knowledge can arrive at the following conclusion about FIG. 6B. When offset current I_{OFFSET1} increases, output current I_{OUT} increases, offset current I_{OFFSET2} increases, and target voltage V_{TARGET} decreases. Thus, LDO 60b can generate a relationship between target voltage V_{TARGET} and output current I_{OUT} similar to that shown by line 18 of FIG. 3, which may reduce output voltage ripple.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A method of reducing ripple for use in a power supply, the power supply providing an output voltage to a load, and causing the output voltage to approach a target voltage, the method comprising:
comparing the output voltage and the target voltage to generate a control signal; and
changing the target voltage according to the control signal;
wherein the target voltage is lowered when the control signal indicates that output current increases.

2. The method of claim 1, wherein the power supply comprises an error amplifier having a positive input node (non-inverted input node), a negative input node (inverted input node), and an output node, the method further comprising:
coupling the positive input node to a reference voltage;
coupling the negative input node to the output voltage;
using voltage of the output node as the control signal;
generating an offset current according to voltage of the output node; and
performing at least one of the following steps:
injecting the offset current from the negative input node; and
extracting the offset current from the positive input node.

3. The method of claim 1, wherein the power supply is a switching power supply comprising a power switch and a compensation circuit, the method further comprising:
using a compensation voltage of the compensation circuit as the control signal; and
controlling duty cycle of the power switch according to the control signal.

4. The method of claim 1, wherein the power supply is a low dropout regulator comprising a power component having an input power node, an output power node, and a control node, the output power node used for providing the output voltage, the method comprising:
comparing a reference voltage and a feedback voltage, and generating a differential signal from two differential output nodes, wherein the feedback voltage represents the output voltage;
generating the control signal at the control node according to the differential signal;
generating an offset current according to the control signal; and
injecting the offset current into or extracting the offset current from at least one of the two differential output nodes.

5. A power supply, the power supply providing an output voltage to a load, and causing the output voltage to approach a target voltage, the power supply comprising:
a compensation circuit for comparing the output voltage and the target voltage to generate a control signal; and
a bias circuit for changing the target voltage according to the control signal;
wherein the target voltage is lowered when the control signal indicates that the output current increases.

6. The power supply of claim 5, wherein the compensation circuit comprises an error amplifier having a positive input node (non-inverted input node), a negative input node (inverted input node), and an output node, wherein the positive input node is coupled to a reference voltage, the negative input node is coupled to the output voltage, the output node provides the control signal, and the bias circuit generates an offset current according to the control signal, the offset current injected into the negative input node or extracted from the positive input node.

7. The power supply of claim 5, wherein the power supply is a switching power supply comprising a power switch and a compensation circuit, and a compensation voltage of the compensation circuit acts as the control signal for controlling duty cycle of the power switch.

8. The power supply of claim 5, wherein:
the power supply is a low dropout regulator comprising:
a power component having an input power node, an output power node, and a control node, the output power node used for providing the output voltage;
the compensation circuit comprises:
a comparator for comparing a reference voltage and a feedback voltage, and generating a differential signal from two differential output nodes, wherein the feedback voltage represents the output voltage; and
a buffer stage for generating the control signal at the control node according to the differential signal; and
the bias circuit generates an offset current according to the control signal, and injects the offset current into or extracts the offset current from at least one of the differential output nodes.
